(19) United States
(12) Patent Application Publication
(10) Pub. No.: US 2012/0089458 A1
(43) Pub. Date: Apr. 12, 2012

(54) MANAGEMENT OF VIDEO DATA FOR ADVERTISING OVER A COMMUNICATIONS NETWORK

(76) Inventor: Barbara Morello, Palmetto Bay, FL (US)

(21) Appl. No.: 12/901,946

(22) Filed: Oct. 11, 2010

(51) Int. Cl. G06Q 30/00

(52) U.S. Cl. 705/14.49; 705/14.72

(57) ABSTRACT

A method on a server for creating and managing video for use as advertising over a communications network can be provided. The method can include providing a graphical user interface (GUI) to a user over the communications network and receiving, via the GUI, descriptive information pertaining to the user's business, at least one image pertaining to the user's business and video preferences of the user. The method can further include generating a profile for the user's business and a video, both of which are based on data which was received via the GUI and indexing the profile and the video based on the descriptive information. The method can further include providing a second GUI to consumers over the communications network, wherein the second GUI allows consumers to search for the profile and the video based on search parameters and allows consumers to view the profile and the video.

### BACKGROUND OF THE INVENTION

1. Field of the Invention

The present invention relates to the field of advertising and marketing and, more specifically, the present invention relates to the field of scalable systems for managing large volumes of video data over a communications network.

2. Description of the Related Art

Historically, the only methods for advertisers to showcase their products and services have been print media and in-person advertising and marketing. With the birth of the electronic age, however, a plethora of additional options became available for businesses seeking to advance their brands. The emergence of radio and television, for example, afforded advertisers access to previously unavailable technologies—radio frequency-transmitted audio and video. In the same thread, the Internet now affords advertisers with additional venues for reaching consumers. Videos including synchronized audio, banner ads and/or hyperlinked text ads, for example, are now well-known advertising methods on the Web.

Video for marketing purposes on the Web, however, is currently under-used. One of the reasons for the dearth of video advertising on the Web is the storage and bandwidth requirements associated with this medium. Video usually involves large file sizes that translate into significant hardware requirements and the cost/maintenance associated with those requirements. Video also requires considerable bandwidth in order to adequately deliver it to the end-user via the Web. Sufficient bandwidth can be expensive and difficult to obtain, thus compounding the problems associated with administering and delivering video over the Web.

Various approaches to online video advertising currently exist. These approaches usually disclose a Web-accessible network that stores the video advertisements and makes them available for viewing by users accessing the network. These approaches, however, have their drawbacks. One problem with said approaches is their limited scalability. Although the management of small amounts of video data may be trivial, as the amounts of video data being managed increases into significant quantities, important scalability issues, which threaten the viability of the entire system, begin to arise. Another problem with conventional approaches is the lack of user-friendliness. Producing professional-looking videos is still a tedious, time-consuming task that requires significant editing and photographic skills not possessed by the typical advertiser. As such, access to such videos for the purpose of advertising is still out of reach for many advertisers.

Therefore, what is needed is a system and method for improving the problems with the prior art, and more particularly for a more efficient method and system for creating and managing video data for use as advertising over a communications network.

### BRIEF SUMMARY OF THE INVENTION

Embodiments of the present invention address deficiencies of the art in respect to online marketing and advertising and provide a novel and non-obvious method for management of video for advertising online. In an embodiment of the invention, a method on a server for creating and managing video for use as advertising over a communications network can be provided. The method can include providing a graphical user interface to a user over the communications network and receiving, via the graphical user interface, descriptive information pertaining to the user's business, at least one image pertaining to the user's business and video preferences of the user. The method can further include generating a profile for the user's business and a video, both of which are based on data which was received via the graphical user interface and indexing the profile and the video based on the descriptive information. The method can further include providing a second graphical user interface to consumers over the communications network, wherein the second graphical user interface allows consumers to search for the profile and the video based on search parameters and allows consumers to view the profile and the video.

In another embodiment of the invention, a server for creating and managing video for use as advertising over a communications network can be provided. The server includes a network interface for providing a graphical user interface to a user over the communications network and a receiver for receiving, via the graphical user interface, descriptive information pertaining to the user's business, at least one image pertaining to the user's business and video preferences of the user. The server further includes a processor for configured for generating a profile for the user's business and a video, both of which are based on data which was received via the graphical user interface, indexing the profile and the video based on the descriptive information and providing a second graphical user interface to consumers over the communications network, wherein the second graphical user interface allows consumers to search for the profile and the video based on search parameters and allows consumers to view the profile and the video.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for managing the creation and delivery of advertising video data over a communications network, in accordance with one embodiment of the present invention.

FIG. 2 is a flow chart describing the control flow of the process for generating, indexing and storing advertising video data over a communications network, in accordance with one embodiment of the present invention.

FIG. 3 is a flow chart describing the control flow of the process for searching and viewing advertising video data over a communications network, in accordance with one embodiment of the present invention.

### DETAILED DESCRIPTION OF THE INVENTION

The present invention improves upon the problems with the prior art by providing a more effective advertising video generation method and a more efficient method and system for managing advertising video data and related information over a communications network such as the Internet. In one embodiment, the present invention provides a novel method for allowing advertisers to easily upload and select data and subsequently automatically generate a short advertising video (such as 30 sec.) based on the uploaded and selected data. The aforementioned method is beneficial for advertisers as it eliminates the high time and cost investment usually associated with the production of a professional, customized advertising video. Further, the aforementioned method provides an incentive for advertisers to continuously change its advertising video due to the relative ease and lower time and cost investment associated with each generated advertising video. Advertisers are also incentivized to create more than one advertising video as a result of the lower expenditure associated with each generated video. Lastly, consumers viewing the advertising videos are attracted to the greater variety and constantly changing nature of the advertising videos.

Additionally, the present invention provides a scalable and easy-to-use system for managing large amounts of advertising video data. More specifically, advertisers are able to easily enter profile data and generate videos, which are indexed according to the profile data. Thereafter, the profiles and data can easily be searched and viewed online by consumers seeking providers of products or services. In this way, the present invention improves over the prior art by providing a scalable and centrally networked system for gathering and managing advertising video data and providing a user-friendly interface for allowing consumers to easily search and view the video data to facilitate their buying decisions. Further, the concise quality of the advertising videos attracts viewers and lowers the storage and bandwidth requirements usually associated with storing and delivering advertising videos over the Web.

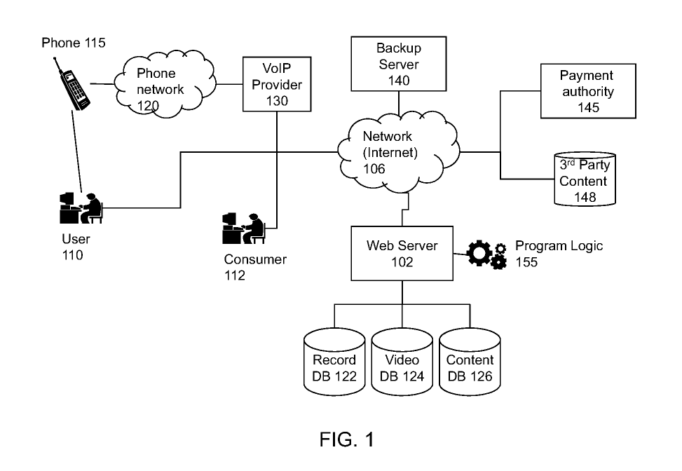

Referring now to the drawing figures in which like reference designators refer to like elements, there is shown in FIG. 1 an illustration of a block diagram showing the network architecture of a software application in accordance with the principles of the present invention. FIG. 1 shows an embodiment of the present invention wherein a user 110, comprising a user and a computer, interacts with web server 102 over a network 106, which can be a packet switched network such as the Internet or the World Wide Web. The computer of user 110 can be a desktop, a laptop, handheld computer, a smart phone, a tablet computer or the like. Likewise, consumer 112 interacts with web server 102 over the network 106.

Web server 102 includes a software engine that delivers applications, videos and other data to user 110. Web server 102 includes a software engine that delivers applications, videos and other data to consumer 112 based on search parameters or identifying information selected by the client. The software engine of server 102 may perform other video delivering processes such as video streaming or any other standard for transferring multimedia data in a stream of packets that are interpreted and rendered, in real time, by a software application as the packets arrive. It should be noted that although FIG. 1 shows only one user 110, one consumer 112 and one web server 102, the system of the present invention supports any number of client users and web servers connected via network 106.

Server 102 includes program logic 155 comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages). Program logic 155 may reside on a client computer, the server 102 or any combination of the two.

In one embodiment of the present invention, the network application provided by the web server 102 of FIG. 1 (i.e., program logic 155) is a client-server application having a client portion that resides on client computer 110, 112 and a server application that resides on web server 102. For example, the network application can be a web interface that is accessed by client computer 110 via network 106. In another embodiment of the present invention, the web server 120 delivers to client 110 an application having only a client portion that resides on client computer 110. For example, the application can be a web browser extension or web browser add-on, which is an installable enhancement to a web browser. The web browser extension or web browser add-on may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

FIG. 1 further shows that web server 120 is connected to a record database 122, a video database 124 and a content database 126. Database 122 is used to store records, such as profiles and user account data, which have been created for each user 110. Video database 124 stores videos that have either been generated by server 102 based on user-provided data. Database 126 stores all other content associated with a user profile, such as still images, audio data, etc.

FIG. 1 also shows a payment authority 145 to effectuate payments by users for the advertising services of server 102. In one embodiment of the present invention, the payment authority 145 is a payment gateway, which is an e-commerce Application Service Provider (ASP) service that authorizes payments for e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc.

FIG. 1 also shows a third party content provider 148, which may provide content such as videos, still images and audio in exchange for payment. FIG. 1 further shows a mobile phone 115, which may be connected to a phone network 120, which may be the public switched telephone system or a cellular phone system, via a wired or wireless connection. A voice over Internet Protocol (VoIP) provider 130 interfaces with the phone network 120 to capture certain calls and voice data resulting from such calls. The VoIP provider 130 is further connected with the network 106.

Lastly, FIG. 1 shows a backup server 140 which makes copies of data on server 102 and/or its associated databases, so that these additional copies may be used to restore the original after a data loss event. The backup server 140 may be used to restore a state following a disaster or to restore small numbers of files after they have been accidentally deleted or corrupted.

Note that although server 102 is shown as a single and independent entity, in one embodiment of the present invention, the functions of server 102 may be integrated with the functions of another entity, such as entities 130, 140, 145, and 148 of FIG. 1. Further server 102 and its functionality, according to a preferred embodiment of the present invention, can be realized in a centralized fashion in one computer system, or in a distributed fashion where different elements are spread across several interconnected computer systems.

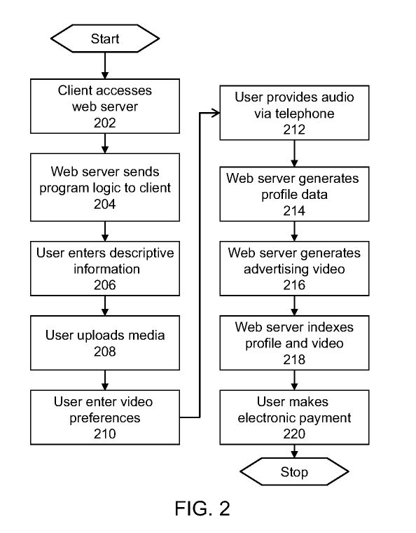

FIG. 2 is a flow chart describing the control flow of the process for generating, indexing and storing advertising video data over a communications network, in accordance with one embodiment of the present invention. The flow chart of FIG. 2 describes the process undertaken by an advertiser 110 seeking to generate an online profile and associated advertising video for his business using the system of the present invention. The flow chart of FIG. 2 is described in association with FIG. 1.

In a first step 202, a client application 102, such as a web browser, executing on the client computer of user 110 accesses web server 102 over network 106. User 110 may, for example, access the web site operated by web server 102 by sending an HTTP request to web server 102. In step 204, the server application of web server 102 (i.e., program logic 155) transmits certain program logic to user 110. The program logic displays a graphical user interface on the computer of user 110.

In step 206, the user 110 enters descriptive information into the graphical user interface, wherein the descriptive information may include a type of the user's business, the name of the business, contact information of the business (i.e., name, address, telephone number, email address, etc.), a rating of the business, a URL for a web site of the business, a list of keywords or tags associated with the business, etc.

In step 208, the user 110 may upload or select videos, audio and images for use in an advertising video for the user's business. In this step, the user 110 may upload, via network 106, videos, audio and still images in his possession. The media uploaded by the user 110 may be stored in content database 126 with an association to the profile of the user's business in database 122. Alternatively, the server 102 may present, via the graphical user interface, still images and videos available to the user 110. The server 102 may make certain content available to the user 110 for pay while other content is available free of charge. In another alternative, third party content provider 148 may provide content in exchange for payment or free of charge.

In step 210, the server 102 may present, via the graphical user interface, video preferences available to the user 110 for inclusion in the advertising video for the user's business. In this step, the user 110 selects video preferences, which may include still image selections, video segment selections, audio segment selections, color selections, icon selections or the like.

In optional step 212, the user 110 may provide audio via telephone 115 for inclusion in the video generated for the user's business. In this step, the user 110 calls a predefined telephone number using telephone 115 and phone network 120. Once connected to a VoIP provider 130, the user 110 provides an audio segment that is collected by VoIP provider 130 and transmitted to the server 102 via network 106. The audio provided by the user 110 may be stored in content database 126 with an association to the profile of the user's business in database 122.

In step 214, the application of server 102 (i.e., program logic 155) generates a profile for the user's business based on the descriptive information provided by the user 110. The profile may be stored in record database 122, including pointers or addresses for associated advertising video(s) in video database 124 and associated content in content database 126. The profile may comprise attribute-value pairs wherein a set of attributes, representing categories, are paired with actual values. An example of a list of such attribute-value pairs is shown below:
Business Name: Frank's Service Center
Location: Miami Beach
Category: Automotive Repair
Address: 123 Elm Street, Miami Beach, Fla.
Keywords: Auto, repair, car, body work, exhaust system, tire change

In step 216, the server 102 generates an advertising video based on data which was received via the graphical user interface, namely, videos, audio and still images uploaded or selected by the user 110, as well as the video preferences selected by the user 110. The advertising video may further based on data which was received via the VoIP provider 130. The video file created by server 102 may exist in any of a variety of formats, such as AVI, FLV, MOV, MPEG, XVID, SWF, MPEG4, WMV, RM and DIVX. The advertising video may further be stored in video database 124. In one embodiment, the advertising video is set to a uniform length, such as thirty seconds.

In step 218, the server 102 indexes the profile of the user's business and the associated advertising video based on the textual data in the profile. The indexing of the profiles and associated advertising videos allows the profiles and videos to easily be searched and viewed online by consumers seeking providers of products or services, so as to facilitate their buying decisions.

In optional step 220, the user 110 may input electronic payment information (such as name, address, credit card information) into the graphical user interface for payment for the generation of the video and profile, as well as the hosting of the same. Subsequently, the payment authority 145 receives the electronic payment information and credits the user for such payment.

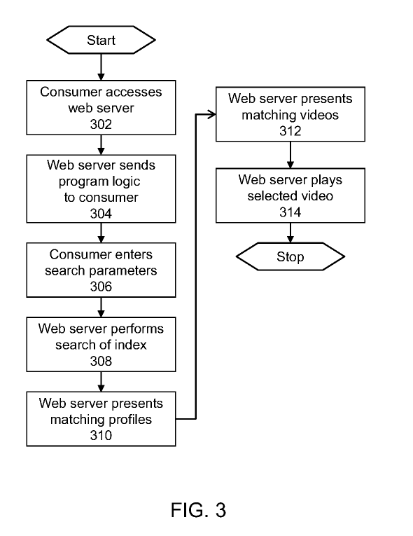

FIG. 3 is a flow chart describing the control flow of the process for searching and viewing advertising video data over a communications network, in accordance with one embodiment of the present invention. The flow chart of FIG. 3 describes the process undertaken by a consumer 112 when seeking businesses that provide products or services using the system of the present invention. The flow chart of FIG. 3 is described in association with FIG. 1.

In a first step 302, a client application 102, such as a web browser, executing on the client computer of consumer 112 accesses web server 102 over network 106. Consumer 112 may, for example, access the web site operated by web server 102 by sending an HTTP request to web server 102. In step 304, the server application of web server 102 (i.e., program logic 155) transmits certain program logic to consumer 112. The program logic displays a graphical user interface on the computer of consumer 112.

In step 306, the consumer 112 enters search parameters into the graphical user interface, wherein the search parameters may include text that defines a variety of data, such as a type of business, the name of a business, a rating of a business, a list of keywords associated with a business, etc. In step 308, the program logic 155 performs a search of the index of profiles and advertising videos based on the search parameters entered by the consumer 112. Specifically, the program logic 155 searches the text within any profile for the search parameters, and/or the text of the videos associated with the users 110.

In step 310, the server 102 may present, via the graphical user interface, one or more profiles for businesses that matched the consumer's search parameters. In step 312, the server 102 may present, via the graphical user interface, one or more advertising videos associated with the profiles of the businesses that matched the consumer's search parameters. In step 314, upon detecting a click or other user interaction with the graphical user interface, the server 102 plays the selected advertising video. The playing of the advertising video may be streamed, wherein video data is transferred in a stream of packets that are interpreted and rendered, in real time, by a software application as the packets arrive. Additionally, the transfer of the video file may include compression and/or encryption upon transmission and decompression and/or decryption upon reception.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a server for creating and managing video for use as advertising over a communications network, comprising:
providing a graphical user interface to a user over the communications network;
receiving, via the graphical user interface, descriptive information pertaining to the user's business, at least one image pertaining to the user's business and video preferences of the user;
generating a profile for the user's business and a video, both of which are based on data which was received via the graphical user interface;
indexing the profile and the video based on the descriptive information; and
providing a second graphical user interface to consumers over the communications network, wherein the second graphical user interface allows consumers to search for the profile and the video based on search parameters and allows consumers to view the profile and the video.

2. The method of claim 1, further comprising a step before the step of generating of:
receiving, via the graphical user interface, at least one video pertaining to the user's business.

3. The method of claim 1, further comprising a step before the step of generating of:
receiving, via an interface to the public-switched telephone network, at least one audio segment pertaining to the user's business.

4. The method of claim 3, wherein the step of generating further comprises:
generating a profile for the user's business and a video, both of which are based on the data received via the graphical user interface and the audio segment.

5. The method of claim 1, wherein the step of receiving descriptive information further comprises:
receiving, via the graphical user interface, descriptive information pertaining to the user's business, wherein the descriptive information includes at least one of:
a type of the business;
contact information of the business;
an address of the business;
a telephone number of the business;
a URL for a web site of the business; and
a list of keywords associated with the business.

6. The method of claim 5, wherein the step of receiving video preferences further comprises:
receiving, via the graphical user interface, video preferences of the user, wherein video preferences include at least one of:
still image selections;
video segment selections;
audio segment selections;
color selections; and
icon selections.

7. The method of claim 6, wherein the step of generating further comprises:
generating a profile for the user's business based on the descriptive information received via the graphical user interface, wherein the profile comprises a textual set of attribute-value pairs.

8. The method of claim 7, wherein the step of generating further comprises:
generating a video based on the data received via the graphical user interface, wherein the video includes the at least one image pertaining to the user's business and the video preferences of the user.

9. The method of claim 1, wherein the step of providing a second graphical user interface further comprises:
providing a second graphical user interface to consumers over the communications network;
receiving, via the second graphical user interface, search parameters; and
searching an index for profiles and videos that match the search parameters.

10. The method of claim 9, wherein the step of providing a second graphical user interface further comprises:
displaying, via the second graphical user interface, profiles and videos that match the search parameters.

11. A server for creating and managing video for use as advertising over a communications network, comprising:
a network interface for providing a graphical user interface to a user over the communications network;
a receiver for receiving, via the graphical user interface, descriptive information pertaining to the user's business, at least one image pertaining to the user's business and video preferences of the user;
a processor for configured for:
generating a profile for the user's business and a video, both of which are based on data which was received via the graphical user interface;
indexing the profile and the video based on the descriptive information; and
providing a second graphical user interface to consumers over the communications network, wherein the second graphical user interface allows consumers to search for the profile and the video based on search parameters and allows consumers to view the profile and the video.

12. The server of claim 11, wherein the receiver receives at least one video pertaining to the user's business.

13. The server of claim 11, wherein the receiver receives, via an interface to the public-switched telephone network, at least one audio segment pertaining to the user's business.

14. The server of claim 13, wherein the step of generating further comprises:
generating a profile for the user's business and a video, both of which are based on the data received via the graphical user interface and the audio segment.

15. The server of claim 11, wherein the descriptive information includes at least one of:
a type of the business;
contact information of the business;
an address of the business;
a telephone number of the business;
a URL for a web site of the business; and
a list of keywords associated with the business.

16. The server of claim 15, wherein video preferences include at least one of:
still image selections;
video segment selections;
audio segment selections;
color selections; and
icon selections.

17. The server of claim 16, wherein the step of generating further comprises:
generating a profile for the user's business based on the descriptive information received via the graphical user interface, wherein the profile comprises a textual set of attribute-value pairs.

18. The server of claim 17, wherein the step of generating further comprises:
generating a video based on the data received via the graphical user interface, wherein the video includes the at least one image pertaining to the user's business and the video preferences of the user.

19. The server of claim 11, wherein the step of providing a second graphical user interface further comprises:
providing a second graphical user interface to consumers over the communications network;
receiving, via the second graphical user interface, search parameters; and
searching an index for profiles and videos that match the search parameters.

20. A method on a server for creating and managing video for use as advertising over a communications network, comprising:
providing a graphical user interface to a user over the communications network;
receiving, via the graphical user interface, descriptive information pertaining to the user's business, at least one image pertaining to the user's business and video preferences of the user;
receiving, via an interface to a public-switched telephone network, at least one audio segment from the user pertaining to the user's business.
generating a profile for the user's business and a video, both of which are based on data which was received via the graphical user interface and the audio segment;
indexing the profile and the video based on the descriptive information; and
providing a second graphical user interface to consumers over the communications network, wherein the second graphical user interface allows consumers to search for the profile and the video based on search parameters and allows consumers to view the profile and the video.
